(19) United States
(12) Patent Application Publication
(10) Pub. No.: US 2003/0058914 A1
(43) Pub. Date: Mar. 27, 2003

(54) Optically pumped solid-state laser

(76) Inventors: Claus-Rudiger Haas, Aachen (DE); Reinhold Dinger, Glinde (DE); Dieter Hoffmann, Simmerath (DE)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 10/223,512

(22) Filed: Aug. 19, 2002

Related U.S. Application Data
(63) Continuation of application No. PCT/EP00/12943, filed on Dec. 19, 2000.

(51) Int. Cl. H01S 3/091; H01S 3/092; H01S 3/08

(52) U.S. Cl. 372/70; 372/99

(57) ABSTRACT

An optically pumped solid-state laser includes a laser medium surrounded by a pumping radiation reflector having at least one opening for injecting into the pumping radiation reflector pumping radiation emitted by a pumping radiation source Disposed between the pumping radiation source and the laser medium is a beam guiding and/or beam shaping optical system that includes at least one optical element disposed inside the pumping radiation reflector in the beam path of the pumping radiation source, the optical element varying the power density distribution of at least a portion of the pumping radiation directed immediately onto the laser medium.

### CROSS-REFERENCE TO RELATED APPLICATION

This application is a continuation of copending International Application No. PCT/EP00/12943, filed Dec. 19, 2000, which designated the United States and was not published in English.

### BACKGROUND OF THE INVENTION

1. Field of the Invention

The present invention relates to an optically pumped solid-state laser having a laser medium that is surrounded by a pumping radiation reflector having at least one opening for injecting into the pumping radiation reflector pumping radiation that is emitted by a pumping radiation source, a beam guiding and/or beam shaping optical system being disposed between the pumping radiation source and the laser medium.

Such a configuration is disclosed, for example, in German Published, Non-Prosecuted Patent Application DE 689 15 421, corresponding to U.S. Pat. No. 5,033,058 to Cabaret et al. In the Cabaret configuration, a laser rod is surrounded at a spacing by a glass tube. The outside of the glass tube is provided with a reflective coating. An annular space that is filled with a cooling fluid is left between the glass tube and the laser medium. The reflective coating has slit-shaped openings that run parallel to the axis of the laser medium and that in each case are associated with a pumping radiation source in the form of laser diodes. The laser diodes are assigned lenses that are situated between the laser diodes and the outside of the reflector and with the aid of which the divergent beams output by the laser diodes are converted into parallel beams. The width of the parallel radiation field is selected such that the cross section of the laser medium is virtually entirely illuminated.

The configuration specified above describes a fundamental possibility for optically pumping a laser medium. Pumping radiation reflectors as described above are frequently also configured as separate components that surround the cooling tube, as previously described, at a spacing. The pumping radiation reflector is configured, as a rule, such that it serves to shape the pumping radiation, for example, to homogenize the pumping power density distribution in the laser medium. High-power diode lasers are used as a rule in such a case as source for the pumping radiation. For the purpose of increasing the power, the latter can be stacked in different ways, for example, in the form of horizontal and vertical stacks, around the laser medium with n-fold symmetry. The reflectors are usually provided with a silvering by dielectric layers or by metal layers, for example, gold. Alternatively, the reflector is configured as a diffuse reflector. Use is typically made for this purpose of diffusely scattering ceramics of low absorption (for example, aluminum oxide) or Teflon-based structures (for example, SPEKTRALON®, a registered trademark of LABSPHERE).

It is basically desired in the case of such configurations to configure the pumping power density distribution inside the laser medium homogeneously in order, inter alia, to reduce undesired, thermally induced disturbances, for example, thermally induced stresses or temperature-dependent variations in the refractive index in the laser medium because it is precisely such disturbances that lead to a low efficiency and poor beam quality of such lasers.

Consequently, many publications exist in the prior art that are concerned with the injection of pumping radiation into the laser medium. The types of configurations described in the text that follows are to be distinguished in essence in this case.

1. The direct injection of the pumping radiation into the reflector opening without optical elements for beam shaping and/or guidance. Such a configuration is illustrated and described in, for example, “Diode Pumped Solid State Lasers in the kW-Range” by T. Brand, B. Ozygus, H. Weber, International Journal Laser Physics. In a configuration illustrated in this publication, the rod-shaped laser material is surrounded at a spacing by a cooling tube; disposed around the configuration is a reflector that, again, is U-shaped when seen in cross section. Diode lasers are associated with the opening region of this reflector.

2. Injecting the pumping radiation into the reflector opening by waveguides. Described for such a purpose, for example, in “62-W cw TEMOO Nd:YAG laser side-pumped by fiber-coupled diode lasers” by D. Golla et al., Optics Letters, Vol. 21, No. 3, Feb. 1, 1996, are pumping configurations in which the pumping radiation is guided by a field of cylindrical waveguides to the slit-shaped openings of the reflector that surrounds the laser rod and the cooling jacket tube, and is injected into the reflector. Different shapes of planar waveguides, such as are illustrated in FIG. 26 of European Patent Application EP 0 798 827 A2, corresponding to U.S. Pat. No. 5,883,737 to Fujikawa et al., for example, exist own as an alternative to cylindrical waveguides.

3. Injecting the pumping radiation into the reflector opening by beam shaping optical systems, for example, by focusing the radiation by lenses, with the aim of configuring the reflector opening to be as small as possible to reduce the losses. Such measures are described, for example, in 69-W-average-power Yb:YAG laser” by Hans Bruesselbach and David S. Sumida, Optics Letters/Vol. 21, No. 7, Apr. 1, 1996.

4. Finally, beam guiding and beam shaping configurations can be constructed by combining waveguides and beam shaping optical systems such as are described above under items 2 and 3.

As already explained above, increasing use is being made of individual diode lasers or so-called diode laser stacks as pumping radiation sources. Such diode laser stacks can include horizontally and/or vertically stacked diode lasers. Such configurations are described in the most varied forms in European Patent Application EP 0 798 827 A2, corresponding to U.S. Pat. No. 5,883,737 to Fujikawa et al.

Solid-state laser amplifiers and solid-state lasers that are pumped by diode lasers are also described in European Patent Application EP 0 867 988 A2. The configuration according to this printed publication is distinguished in that the diode laser pumping radiation is not injected directly in the direction of the axis of the laser medium, but in a direction that, if anything, is tangential to the cross-section of the laser medium. The aim of such a measure is to improve the homogeneity of the distribution of the temperature gradients with reference to a segment of the laser rod. German Published, Non-Prosecuted Patent Application DE 199 08 516 A1, corresponding to U.S. Pat. No. 6,282,217 to Takase, discloses an optically pumped solid-state laser in which a scattering surface is provided in the beam path of the pumping radiation to ensure a uniform illumination of the laser rod when using semiconductor laser diodes as a pumping light source. Provided for such a purpose in one embodiment is an optically transparent cooling tube that is roughened on its inner surface. However, the absence of a reflector greatly reduces the efficiency in laser output power, that is to say, the conversion of pumping power, particularly in the case of thin or lowly doped laser rods.

More or less pronounced inhomogeneities in the pumping power density distribution in the laser medium that lead to undesired, thermally induced disturbances, for example, thermally induced stresses and temperature-dependent variations in the refractive index, in the laser medium occur in the case of all the above-named configurations and methods of procedure of the injection of pumping radiation. These disturbances, therefore lead to a lower efficiency and poorer beam quality of the laser. Such an effect occurs all the more strongly when the solid body is pumped by the radiation output by diode lasers because diode lasers include a multiplicity of individual pumping light sources with production-induced scattering of the characteristic properties of the emitted radiation (wavelength, optical power, angle of emission). In addition, these parameters are subject to aging effects (the wavelength drifts to higher values over the service life, the power drops over the service life by 20% (the service life of the diode laser is defined when 80% of the initial laser power is reached on the same current)). A further cause of changes in the emission characteristic (expressed, for example, by the reduction in the angle of emission of the emitted pumping radiation) results from the development of the semiconductor structures. Moreover, the radiation output by diode laser arrays is distributed relatively inhomogeneously as a consequence of its multiple symmetry and its characteristic.

### SUMMARY OF THE INVENTION

It is accordingly an object of the invention to provide an optically pumped solid-state laser that overcomes the hereinafore-mentioned disadvantages of the heretofore-known devices of this general type and that, in contrast with the prior art, achieves, on one hand, a more uniform illumination of the laser medium and, on the other hand, an efficient utilization of the pumping power, and reduces or substantially avoids, in particular, the undesired, thermally induced disturbances.

With the foregoing and other objects in view, there is provided, in accordance with the invention, an optically pumped solid-state laser, including a pumping radiation reflector having at least one opening for injecting into the pumping radiation reflector pumping radiation to be emitted in a beam path by a pumping radiation source, a laser medium surrounded by the pumping radiation reflector, and a beam altering optical system disposed between the pumping radiation source and the laser medium, the beam altering optical system having at least one optical element disposed inside the pumping radiation reflector in the beam path of the pumping radiation source, the optical element varying a power density distribution of at least a portion of the pumping radiation directed immediately onto the laser medium. The laser can be part of a laser system including the pumping radiation source emitting the pumping radiation.

Starting from an optically pumped laser as specified at the beginning, the beam guiding and/or beam shaping optical system according to the invention includes at least one optical element that is disposed inside the pumping radiation reflector in the beam path of each pumping radiation source, the optical element varying the power density distribution of at least a portion of the pumping radiation directed immediately onto the laser medium.

It has emerged that by disposing an optical element in the beam path of each pumping radiation source inside the pumping radiation reflector it is possible to homogenize the pumping radiation directed onto the medium without loss of efficiency. Such placement of the optical element in the reflector has the result that the radiation reflected at the optical element remains substantially in the reflector (for example, an ideal diffuser transmits or reflects 50% in each case of the radiation incident from one side (Lambert's law)).

It is not possible using optical elements disposed outside the reflector, that is to say, between the radiation source and the opening of the reflector through which the radiation enters the reflector, to homogenize the pumping radiation in the pumping radiation reflector without compromises with regard to efficiency because these elements primarily have the task of focusing the pumping radiation to bring the latter without losses through reflector openings that are as narrow as possible.

Consequently, an optimum shaping of the pumping light in the laser medium, for example, a uniform illumination, is possible, in conjunction with effective utilization of the pumping power, with the aid of the configuration according to the invention because, for example, optical elements with a high degree of scattering and the comparatively high reflected pumping radiation fraction resulting therefrom can be used without losses in efficiency.

The optical element is preferably positioned close to the inside of the pumping radiation reflector. A close configuration of the optical element relative to the inside of the pumping radiation reflector in the region of the opening is understood as a positioning of the optical element such that the latter does not project into the opening, but at most is tangential to the inside of the reflector, that is to say, the reflecting face. It is precisely such a configuration that results in the greatest possible spacing of the optical element from the laser medium, such that a maximum homogenization effect is achieved at the location of the laser medium in the case, for example, of a given degree of scattering of the optical element. The optical element must have a minimum spacing from the reflector opening depending on the width of the reflector gap and the width of the optical element (the latter depending, in turn, on the pumping radiation characteristic downstream of the reflector opening). Such minimum spacing is optimized numerically taking account of the above-named boundary conditions (for example, by a ray tracing program) to the effect that as little pumping radiation as possible strikes the reflector opening as a consequence of reflection at the optical element.

In principle, there are two possibilities of implementing the minimization of the power losses and the homogenization of the power density distribution in the laser medium, aimed at with the aid of the configuration of the optical element according to the invention.

A first technical possibility of implementation for the optical element is a medium that is transparent to the pumping radiation and has a surface that scatters diffusely on one side or both sides, for example, glass with a mechanically or chemically roughened surface. The degree of scattering, which can be influenced through the surface roughness or the surface topology as well as the refractive index of the optical material, here determines both the beam shaping effect (for example, homogenization) and the splitting of the pumping radiation into reflected and transmitted power fractions. In addition, the degree of scattering can be increased through the number of the scattering surfaces, that is to say, also of the sequentially disposed optical elements, if appropriate.

A direct homogenization of the pumping light beam is, therefore, performed in this case, that is to say, the pumping light beam passing through the optical element is expanded and homogenized such that it already has the effect of illuminating the laser rod in a largely uniform fashion upon striking the latter.

In accordance with another feature of the invention, the optical element is provided with a microlens configuration on its radiation entrance and/or radiation exit face, or is configured as a diffractive optical system. In the case of a very short focal length of the microlenses and/or of the diffractive structure, an optical element of such configuration has a similar scattering effect to an optical element with a roughened surface. Moreover, a microlens configuration can be configured specially such that, firstly, a directional characteristic is achieved, that is to say, a different shaping of the radiation in axial and radial directions. In addition, a coating can reduce the reflected pumping radiation fraction. In addition to the beam shaping of the pumping radiation, the adjusting insensitivity of the configuration is an optimization criterion for the dimensions of the microlens configuration. Here, as well, a ray-tracing program performs the optimization numerically. The parameters of the lens array (focal length, dimensions, and number of lenses) are optimized to achieve, for example, a distribution of the pumping radiation in the laser medium that is as homogeneous as possible, in accordance with the stipulation of the emission characteristic of the pumping radiation source as well as the geometric configuration of the remaining elements in the pumping radiation reflector. A diffractive optical system can, likewise, be configured such that the pumping radiation is homogenized with the minimization of the reflected radiation fraction without the need for coatings. Furthermore, it is possible by suitable configuration of the diffractive element (that is to say, of the surface topology) to optimize its beam-shaping characteristic in accordance with the requirement for the optimum pumping radiation distribution in the laser medium. The construction and optimization of the diffractive element are, likewise, possible only by a numerical method. Diffractive elements are produced, for example, by varying the surface topology of optically transparent materials (for example, films or plates made from plastics).

A further way of constructing the optical element is given by the use of a material that is volumetrically scattering and, likewise, does not absorb the pumping radiation, or does so weakly. The degree of scattering can be influenced in such a case both through the number of scattering centers in the optical element and through its thickness (extent in the direction of the pumping radiation). It can be sensible in the individual case to influence the characteristic of the optical element additionally by a suitable surface topology.

Further general advantages of volumetrically scattering materials are their simpler integration into the cooling jacket. Furthermore, an efficient coating of the surface is possible otherwise than in the case of roughened surfaces.

In a simpler, but yet more effective configuration, the optical element can be formed from a milk glass or a pretreated quartz glass. The material marketed by Schott under the designation of “Milchuberfangglas” [“Milk overlay”], for example, is suitable as milk glass. With reference to the pretreated quartz glass, a similar production process is used as in the case of the production of glass ceramic. The aim is to achieve an optimum degree of scattering as well as lower absorption losses.

In accordance with a further feature of the invention, as an alternative to the use of a diffusely scattering optical element, it is provided to make use inside the pumping radiation reflector of an optical element that effects a change in the power density distribution of the pumping radiation inside the pumping radiation reflector by a beam deflection. In such an embodiment, the power density of the pumping optical radiation is modified as a function of direction. By targeted direction-dependent variation of the pumping light beam passing through the optical element, it is possible, in this refinement, to minimize the power losses through the remaining reflector slits in the case of homogenization of the power density distribution in the laser medium effected at the same time by the reflector, in particular, a reflector with a diffusely reflecting surface.

The use of such optical elements is advantageous, in particular, in the case of pumping light reflectors that have an even number of reflector slits or openings, distributed symmetrically around the laser medium, for injecting the pumping light because, due to the targeted beam deflection, it is possible to reduce the fraction of the pumping light projected onto the opposite reflector slit due to the lens effect of the generally cylindrical laser medium, and of the pumping light emerging through the slit. In other words, in such a refinement of the invention, the optical element primarily has the task of influencing the direction of propagation of the pumping light beam such that the latter does not exit through opposite reflector slits. The actual homogenization of the pumping optical radiation is then performed by a suitable configuration of the pumping light reflector that is preferably configured in this case as a diffuse reflector.

Suitable for such a purpose as optical elements are conventional imaging optical elements such as lenses, in particular, cylindrical plano-concave lenses, or generally refracting surfaces, for example, plane-parallel plates or plates of which one flat side is plane and the other flat side has plane faces running inclined to one another. Such elements can be fabricated cost-effectively and are particularly easy to integrate into the wall of the cooling tube by virtue of the fact that the latter is worked on its inner and outer surfaces in an appropriately shaping fashion. The cooling tube can also, in principle, be fashioned as a graded index lens, that is to say, can have a refractive index varying in the radial direction and in the circumferential direction, and can, in this way, effect the desired beam shaping.

In a particularly advantageous refinement of the invention, it is possible to provide, instead of a conventional imaging or beam shaping optical element, an imaging optical element in which a microlens configuration is disposed on the radiation entrance and/or radiation exit face.

In accordance with an added feature of the invention, the optical element is configured as a diffractive optical system to shape the pumping radiation.

The microlens configuration or diffractive optical system used in such a variant differs in this case from the microlens configuration or diffractive optical system used as scattering optical element through a different surface topology, for example, higher focal length of the microlenses.

Existing in the prior art are optically pumped solid-state lasers in which the laser medium is surrounded by a cooling jacket transparent to the pumping radiation. In conjunction with such a configuration, the optical element can be integrated into the wall of the cooling jacket. The integration can be performed, firstly, by mounting the optical element on the outer circumference of the cooling jacket, and also, secondly, by recessing the optical element into the cooling jacket. The recessing can be performed, for example, by appropriately shaping the inner and/or outer surface of the cooling jacket. It must be ensured in each case that, with reference to the opening in the pumping radiation reflector and with reference to the pumping radiation, the optical element is dimensioned and configured such that the requirements with regard to spacing from the laser medium (for example, to achieve a sufficient homogenization effect or general beam-shaping effect for a given degree of scattering) and with regard to the minimization of the losses as a consequence of the reflector openings are fulfilled by radiation reflected at the optical element.

In accordance with an additional feature of the invention, the cooling jacket has an outer circumference and an inner circumference and the optical element is mounted on at least one of the outer circumference and the inner circumference of the cooling jacket.

In accordance with yet another feature of the invention, the laser medium has an imaginary lateral surface therearound and the optical element only partially covers one of the cooling jacket and the imaginary lateral surface around the laser medium.

In accordance with yet a further feature of the invention, the cooling jacket has a wall and the optical element is integrated into the wall of the cooling jacket.

The cooling jacket of such configurations is generally configured as a tube made from a material transparent to the pumping radiation, for example, quartz, that guides a mostly liquid cooling medium, for example, water, likewise transparent to the pumping radiation, along the surface of the laser medium, to cool the laser medium directly.

As a further dimensioning rule for the optical element, in accordance with again an added feature of the invention, the dimensioning and position of the latter should be selected such that the optical element detects only the fraction of the radiation emitted by the pumping radiation source that is directed immediately onto the laser medium, that is to say, where no optical element is present. The configuration ensures that the fraction of the pumping radiation that is substantially responsible for causing the interference in the pumping radiation distribution in the laser medium is adapted (for example, homogenized). It is assumed in this case that the pumping radiation not detected by the optical element is suitably influenced by the reflector (for example, diffuse reflector or suitably shaped, direct reflector).

It is evident that a certain fraction of the pumping radiation that is reflected inside the pumping radiation reflector onto the rear of the optical element, that is to say, onto the side that is averted from the laser medium, is reflected again at a specific fraction into the opening associated with the optical element, and, consequently, exits the pumping radiation reflector. To substantially avoid this, it is preferable to coat the radiation entrance face of the optical element. As an alternative, or in addition thereto, in a particularly preferred refinement, the radiation entrance face of the optical element is tilted by an angle other than 90° with respect to the line between the pumping radiation source and the center of the laser medium such that the fraction of the pumping radiation reflected at the radiation entrance face substantially impinges on the pumping radiation reflector, specifically, outside the assigned opening.

In accordance with yet an added feature of the invention, to achieve a uniform distribution of the pumping radiation in the pumping radiation reflector, it is possible, seen in the circumferential direction of the laser medium, to pump starting from n sides through a respective opening that is respectively assigned an optical element inside the pumping radiation reflector, n being a whole number from 1 to 20. The individual openings should in such a case be distributed uniformly around the circumference, that is to say, they should, in the case of four openings, for example, be offset relative to one another by 90° in each case, and by 45° respectively in the case of eight openings.

Because the laser medium is usually rod-shaped, the openings are preferably configured as slits whose length corresponds approximately to the length of the laser medium. Consequently, the optical elements are then also configured as elongated elements, for example, as a cuboid element or as an elongated part of the cooling jacket.

If use is made of optical elements that have smooth surfaces, for example, on the radiation entrance face, these surfaces should be coated to keep down the reflections at these faces.

A plurality of optical elements can be disposed in series if, with regard to the scattering effect or beam deflection, one optical element per opening is insufficient, or the pumping radiation is influenced too little. In such a case, the respective optical elements that are associated with a pumping radiation source should be constructed such that they replace the single element as far as possible without requiring a larger volume.

It has emerged that it is only with the aid of the measure of assigning the respective opening in the pumping radiation reflector an optical element that is disposed inside the pumping radiation reflector that it is possible to achieve compensation both of the emission characteristic of the pumping radiation source (in this case smaller emission angles as a consequence of the use of large optical cavity diode lasers) and of a higher inhomogeneity of the pumping configuration as a consequence of a reduction in the number of openings in the pumping light reflector. In other words, due to the measures according to the invention, it is possible both to use pumping radiation sources with a smaller emission angle, and to reduce the number of openings in the pumping light reflector. It is decisive in this case that no reduction in the pumping efficiency is to be observed in an optimized configuration (that is to say, there is no change either in the laser threshold in relation to the power of the pumping radiation source, or in the rise in output power over the pumping power).

In accordance with yet an additional feature of the invention, the optical element has a dielectric reflective coating and the pumping radiation reflector substantially shapes the pumping radiation. Preferably, the pumping radiation reflector substantially shapes the pumping radiation both in a radial direction and in an axial direction of the beam path.

Equal laser output powers with comparatively lowly doped solid-state materials can be generated by the use of spectrally relatively narrow-band diode lasers and the better utilization, bound up therewith, of the pumping light power for the population inversion. Such an effect is additionally amplified by the improvement in the utilization of the pumping light power with the aid of the measures according to the invention. The use of diode lasers as pumping light source renders it possible, particularly, to use laser-active solid-state materials that are doped to a much lesser extent with optically active ions than the solid-state materials normally used in the prior art in the case of the same output power and the same pumping power.

In accordance with again another feature of the invention, the laser medium is a solid body doped with an optically active ion from elements selected from the group consisting of transition metals and rare earths and has a doping less than 1 atomic percent, preferably, less than 0.5 atomic percent, in particular less than 0.3 atomic percent. Preferentially, the doping is between 0.05 and 0.3 atomic percent.

In accordance with again a further feature of the invention, the laser medium is YAG doped with neodymium Nd and has a doping less than 0.3 atomic percent, preferably, between 0.05 and 0.3 atomic percent.

In accordance with a concomitant feature of the invention, the pumping radiation source is one of a diode laser and a diode laser configuration.

The better utilization of the pumping light power per se could be used for the purpose of reducing the pumping light power required to achieve a prescribed laser output power, given the same doping. However, it is now possible with the aid of the reduction in the doping, on one hand, to achieve a more homogeneous distribution of the pumping power density absorbed in the laser-active medium because a smaller fraction of the pumping optical radiation injected directly into the laser medium is absorbed, and, therefore, can be homogenized through the reflector. This leads to a reduction in the thermally induced optical interference, and the stability and quality of the laser beam are improved. Moreover, a lower doping also reduces the influence, caused thereby and undesired, of the crystal lattice and the reaction of the latter on the electron shells of the doping ions. This leads to a reduction in the optical and/or thermo-optical interference during operation with a high pumping power density. Moreover, there is an improvement in the efficiency, that is to say, the conversion of the pumping power into laser output power.

Other features that are considered as characteristic for the invention are set forth in the appended claims.

Although the invention is illustrated and described herein as embodied in an optically pumped solid-state laser, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

FIG. 1 is a diagrammatic, cross-sectional view perpendicular to the axis of the laser medium of a laser configuration according to the invention;

FIG. 2 is a diagrammatic illustration of an operation mode of a diffusely scattering optical element of FIG. 1;

FIG. 3 is a diagrammatic illustration of an operation mode of a beam-deflecting optical element of FIG. 1;

FIG. 4 is a fragmentary, diagrammatic illustration of an optical element of FIG. 1 with its radiation entrance face disposed inclined in the pumping radiation reflector;

FIG. 5 is a fragmentary, diagrammatic illustration of another optical element of FIG. 1 with its radiation entrance face disposed inclined in the pumping radiation reflector;

FIG. 6 is a diagrammatic illustration of propagation of the pumping radiation inside the pumping radiation reflector without an optical element according to the invention;

FIG. 7 is a diagrammatic illustration of propagation of the pumping radiation inside the pumping radiation reflector with an optical element according to the invention,

FIGS. 8, 9, and 10 are diagrammatic, cross-sectional views of optical elements according to the invention with different surface structures;

FIGS. 11, 12, and 13 are co-axial graphs respectively illustrating a power density of the pumping radiation in the region of a reflector opening situated opposite the reflector opening of the incoming pumping radiation, without and with the use of an optical element according to the invention;

FIGS. 14, 15, 16, 17, 18, and 19 are diagrammatic, cross-sectional views of optical elements according to the invention with different surface structures;

FIG. 20 is a diagrammatic, cross-sectional view perpendicular to the axis of the laser medium of another laser configuration according to the invention; and

FIG. 21 is a diagrammatic, cross-sectional view perpendicular to the axis of the laser medium of a third laser configuration according to the invention.

### DESCRIPTION OF THE PREFERRED EMBODIMENTS

Referring now to the figures of the drawings in detail and first, particularly to FIG. 1 thereof, there is shown a cylindrical laser medium 1 whose axis is denoted by the reference 2 is surrounded by a cooling tube or cooling jacket 3 at a spacing such that there is left between the laser medium 1 and the cooling jacket 3 an interspace 4 in which a cooling fluid 5, for example, water, is guided. The cooling jacket 3 is, in turn, surrounded by a pumping radiation reflector 7, a further interspace 6 being left. The configuration of the cooling jacket 3 and the pumping radiation reflector 7 is built up concentrically around the axis 2 of the laser medium 1.

Provided as laser medium 1 is a solid body doped with optically active ions, whose doping is substantially lower than the doping normally used with solid-state lasers of the same output power. In particular, YAG doped with neodymium Nd is provided, its doping being lower than 1 atomic percent, in particular, lower than 0.5 atomic percent, and, preferably, amounting to approximately between 0.05 and 0.3 atomic percent.

Formed in the pumping radiation reflector 7 in a fashion distributed uniformly around the circumference are four openings 8 that are elongated slits that run in the direction of the axis 2 of the laser medium 1.

Each opening 8 is assigned a diode laser or a diode laser configuration as pumping radiation source 9, the radiation axis 12 of the pumping radiation 14 output thereby being directed through the respective opening 8 onto the axis 2 of the laser medium 1. A schematically shown, external beam guiding and beam shaping configuration 10 is disposed between the pumping radiation source 9 and the opening 8 of the pumping radiation reflector 7.

An optical element 11 is positioned respectively in the beam path of the pumping radiation 14 inside the pumping radiation reflector 7, that is to say, between the respective opening 8 and the cooling jacket 3. The optical elements 11 serve to distribute the pumping radiation output by the pumping radiation source 9 in the laser medium, to achieve, directly or indirectly together with the pumping radiation reflector 7, a homogeneous distribution of the power absorbed in the laser medium.

The pumping radiation 14 that is output by the pumping radiation source 9 and, for example, has a typically elliptical beam cross section in the case of the use of a diode laser configuration, is initially shaped with the aid of the respective beam guiding and beam shaping configurations 10 such that it can enter the interior of the pumping radiation reflector 7 unimpeded through the respective openings 8 or longitudinal slits. It is to be seen from the schematic in FIG. 1 that the pumping radiation 14, which can be irradiated into the pumping radiation reflector 7, is a function of the divergence angle of the pumping radiation 14, on one hand, and of the opening cross-section of the openings 8, on the other hand. The basic aim is to keep the opening surface area of the openings 8 as small as possible to obtain on the inside of the pumping radiation reflector 7 a reflecting face 13 that is as large as possible. On the other hand, the opening surface areas must be kept large enough to make possible injection of sufficient pumping radiation 14 into the pumping radiation reflector 7, and, thus, to direct it onto the laser medium 1. Due to the optical elements 11 that are assigned to the respective openings 9 in the pumping radiation reflector 7, it is possible for the fraction of the pumping radiation, injected into the pumping radiation reflector 7 through the openings 8, which would illuminate the laser medium without the elements 11, to be influenced with the aid of the elements 11 such that the required pumping radiation distribution (for example, homogeneous power density distribution) in the laser medium 1 is achieved.

What is important is that the respective optical elements 11 are disposed inside the pumping radiation reflector 7, that is to say, seen in the direction of the radiation axis 12 of the diode laser radiation, between the inner reflector surface 13 (reflecting face) (fictitiously completed in the region of the openings 8) of the pumping radiation reflector 7 and the laser medium 1 or the cooling jacket 3.

In the exemplary embodiment in accordance with FIG. 1, the optical elements 11 are disposed between the cooling jacket 3 and the pumping radiation reflector 7. It is possible, in principle, in this case to dispose the optical elements 11 directly at the reflector surface 13, that is to say, directly at the respective reflector opening. It is expedient, in such a case, to use optical elements 11 with a low reflection factor because the pumping radiation 14 reflected by them is lost through the reflector opening.

In the illustration of the principle in accordance with FIG. 2, the optical element 11 disposed in the vicinity of the opening 8 effects a scattering of the pumping radiation 14 passing through it, such that the radiation 14 is, on one hand, homogenized and, on the other hand, guided at least partially past the laser medium 1 onto the inner surface 13 of the pumping radiation reflector 7. Moreover, the effect of the optical element 11 is that the losses due to the pumping radiation 14 exiting from the opposite opening 8 after a single transversal of the laser medium 1 are substantially reduced, as is illustrated with the aid of the beam 14a.

FIG. 3 shows the principle of the mode of operation of an alternative optical element 11, likewise with the aid of a schematic propagation, illustrated in a simplified way for the purposes of illustration, of the pumping radiation 14 downstream of the optical element 11. Here, the effect of the optical element 11 is to change the direction of (deflect) the pumping radiation 14 such that a portion of this pumping radiation 14 (in the figure the entire pumping radiation 14 illustrated in an exaggerated fashion for the purpose of illustration) is guided past the laser medium 1 onto the pumping radiation reflector 7, which is configured in the exemplary embodiment as a diffuse reflector and homogenizes the pumping radiation 14. In this refinement as well, the losses due to the pumping radiation 14 exiting from the opposite opening 8 are reduced.

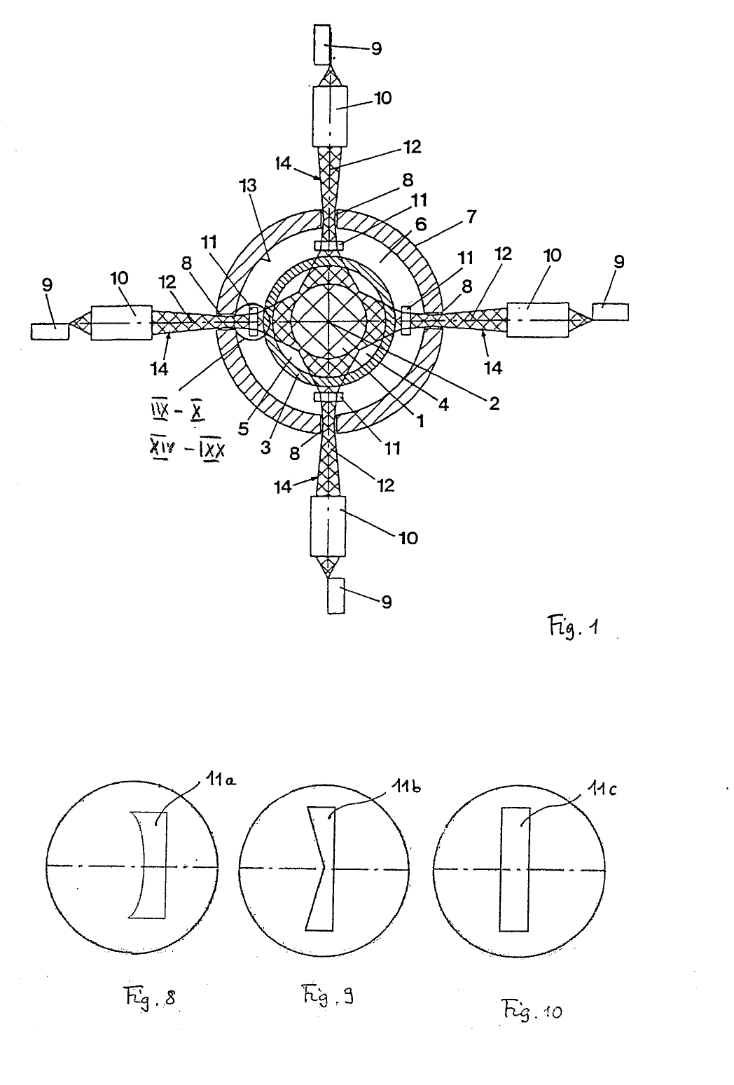

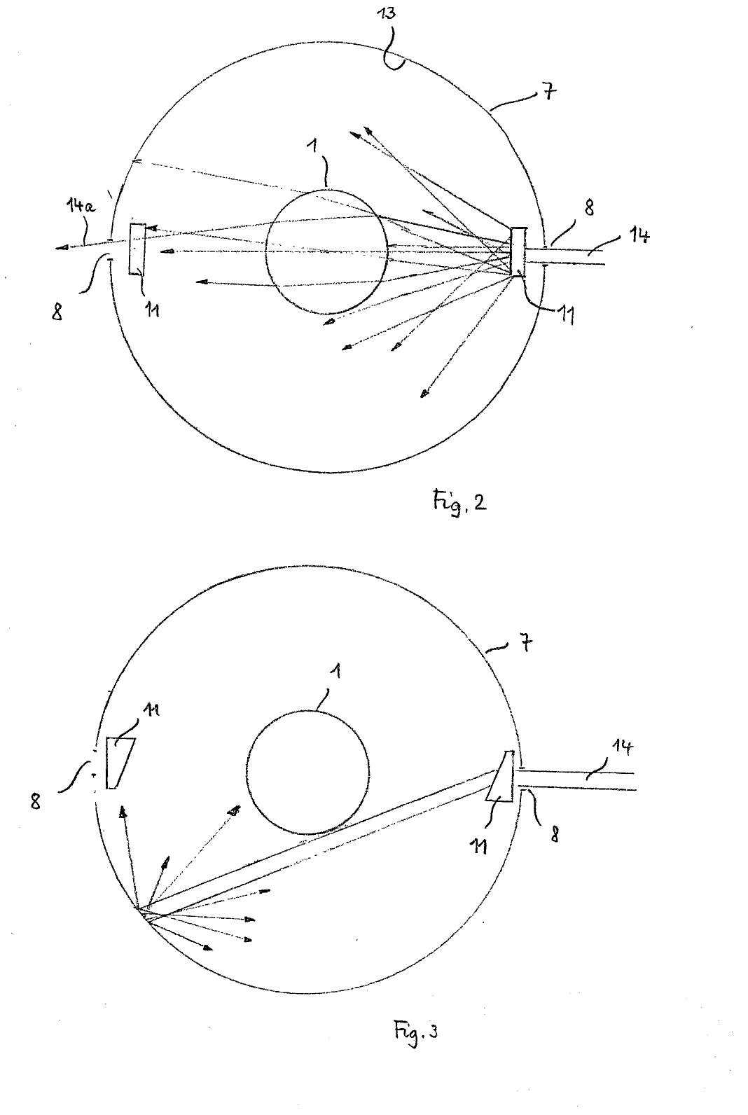

FIGS. 4 and 5 respectively show embodiments in which, in addition, the fraction of the pumping radiation 14 retro-reflected into the opening 8 is reduced by virtue of the fact that the optical element 11 is either tilted (FIG. 4), or at least inclined with its radiation entrance face 116 to the incident pumping radiation 14 (FIG. 5). The angle α between the radiation axis 12 or the center plane of the pumping radiation 14 and the radiation entrance face 116 of the optical element 11 is, therefore, other than 90°; the angle corresponds to approximately 135° in the configuration shown in FIG. 5. The result of such tilting is that pumping radiation 14r that is reflected at the radiation entrance face 116 of the optical element 11 is not retro-reflected immediately onto the opening 8, but is directed onto the reflecting face 13 and remains in the pumping radiation reflector 7. It is also possible to provide a coating of the radiation entrance face 116 instead of or in addition to such a tilting or inclination.

FIG. 6 shows the realistic propagation, calculated with the aid of a ray tracing method, of the pumping radiation 14 inside the pumping radiation reflector 7 in the absence of an optical element according to the invention. Both the cooling jacket 3 and the laser medium 1 act like a focusing lens that focus a substantial portion of the pumping radiation 14 onto the opposite opening 8 such that such portion leaves the pumping radiation reflector 7 after passing only once through the laser medium 1.

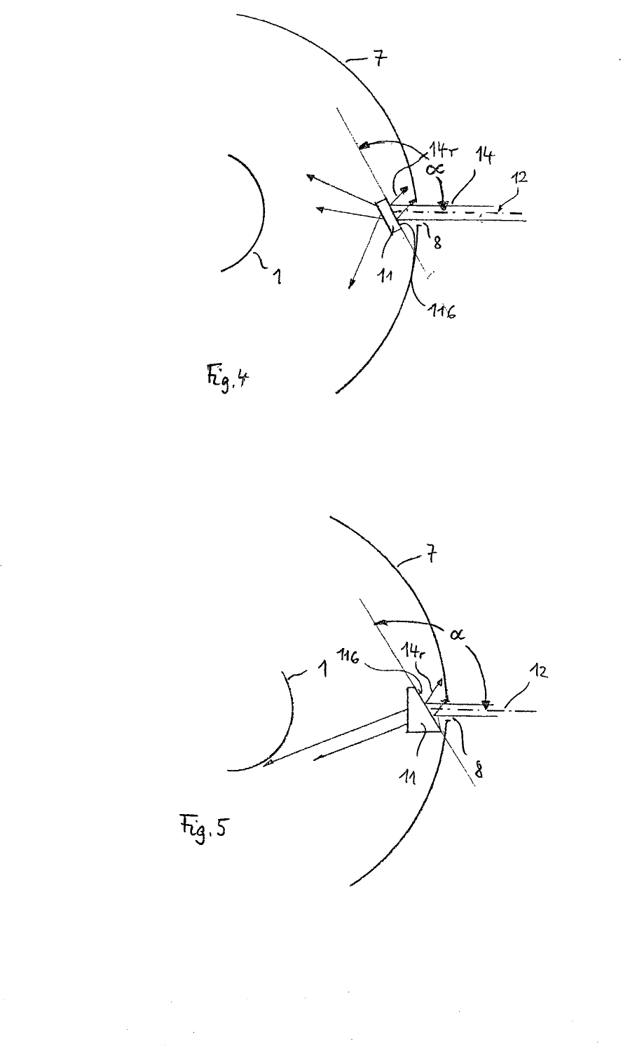

In accordance with FIG. 7, an optical element 11 fashioned as a plane-parallel plate is disposed on the outer surface of the cooling jacket 3. It is clearly to be seen with the aid of the propagation of the pumping radiation 14 downstream of the optical element 11 that, by contrast with the embodiment in accordance with FIG. 6, on one hand, the laser medium 1 is illuminated more uniformly and that, on the other hand, the fraction of the pumping radiation 14 that strikes the opposite opening 8 is substantially reduced.

The following parameters are taken into account for calculating the beam paths:

properties of reflection, transmission, and absorption of all the optical materials (reflector, cooling jacket (here: quartz), cooling medium (here: water), laser medium (here: Nd:YAG)); and

emission characteristic of the pumping radiation source (power density distribution as a function of the angle of emission, spectral distribution of the pumping radiation).

The calculation illustrates only the beam paths in the case of a typical configuration.

Calculating the power density distribution in the laser medium requires substantially more beams than illustrated here for the sake of clarity (a few thousand beam paths are calculated for each of the pumping radiation sources in order to achieve a sufficient spatial resolution in the laser medium).

Based upon the calculation, the optical element 11 is now dimensioned such that it detects at least that pumping radiation 14 coming from the pumping radiation source that would reach the laser medium 1 directly in the absence of the optical element 11. For each optical element 11 there is an optimum position between the laser medium 1 and reflector 7 in which both the requirement for adequate homogenization and the requirement for losses that are as low as possible are fulfilled as a consequence of pumping radiation reflected onto the reflector opening. The optimum position can, then, be found either with the aid of the ray tracing method or experimentally.

The targeted effects of the optical element are:

shaping of the distribution of the absorbed pumping power in the laser medium (both in the radial and in the axial direction), with the aim of obtaining, for example, a distribution of the absorbed pumping radiation in the laser medium that is homogeneous or can be specifically influenced. The reduction in the thermally induced interference in the laser medium (thermal lens effect, depolarization as a consequence of thermally induced stress birefringence) is achieved as such. This leads to a higher output power with the beam quality being preserved, and to a linearization of the output characteristic (output power as a function of the pumping power) of the solid-state laser;

independence from the emission characteristic of the pumping radiation source, for example, as a consequence of technical changes in the diode lasers and/or aging effects of the diode laser; and

avoidance of losses and/or improvement in the pumping efficiency of the solid-state laser.

The effects targeted with the aid of the optical elements can be implemented by different embodiments illustrated below by way of example.

A cylindrical plano-concave lens is provided as optical element 11a in the exemplary embodiment in accordance with FIG. 8.

FIG. 9 shows an embodiment of an optical element 11b in which, instead of a concave light entrance or light exit face, two plane faces that are inclined with respect to one another are provided.

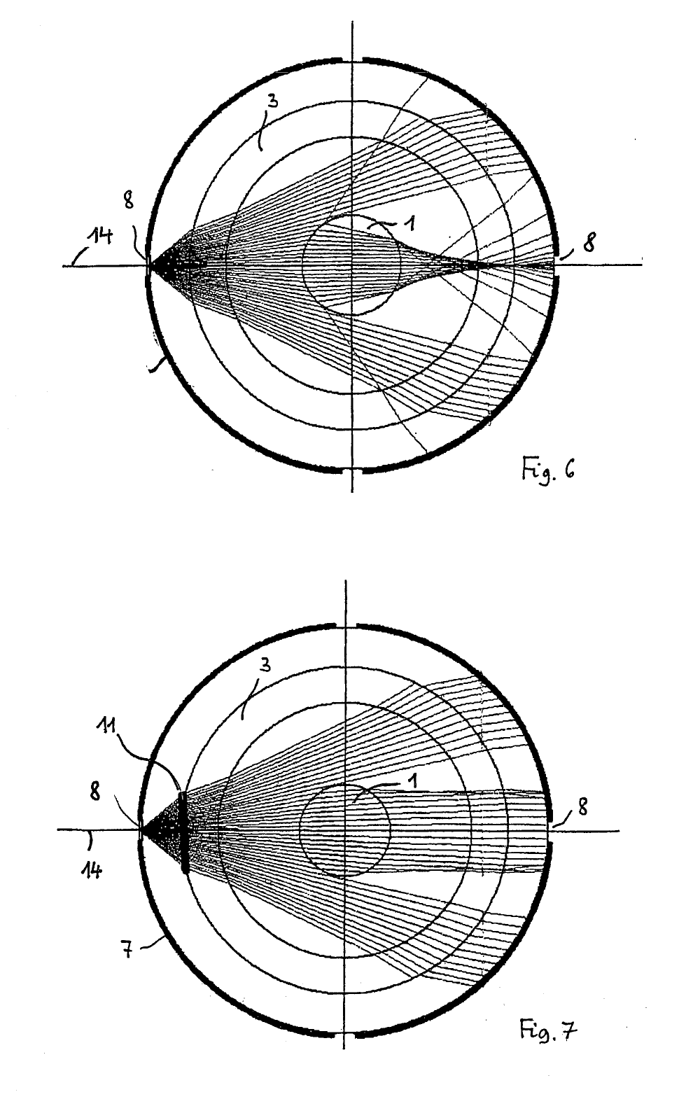

Provided in the exemplary embodiment in accordance with FIG. 10 is an optical element 11c that is constructed from a plane-parallel plate and can be implemented particularly easily in terms of production engineering.

For a cylindrical configuration illustrated in FIG. 1, the power density I of the pumping radiation 14 in the region of the opposite opening 8 of the pumping radiation reflector 7 is plotted in FIGS. 11-13 against the circumference 2rφ, φ=0 being the center of the opening 8 and r being the inside radius of the pumping radiation reflector 7.

FIG. 11 shows the power density in the absence of an optical element 11. It may clearly be seen in this illustration by analogy with the illustration in accordance with FIG. 6 that a high power density that necessarily leads to high reflector losses is present in the region of the opening 8.

The use of an optical element 11c including a simple plane-parallel plate (FIG. 10) already leads to a significant reduction in the power density in the region of the opening 8, as may be seen from the substantially lower maximum in FIG. 12.

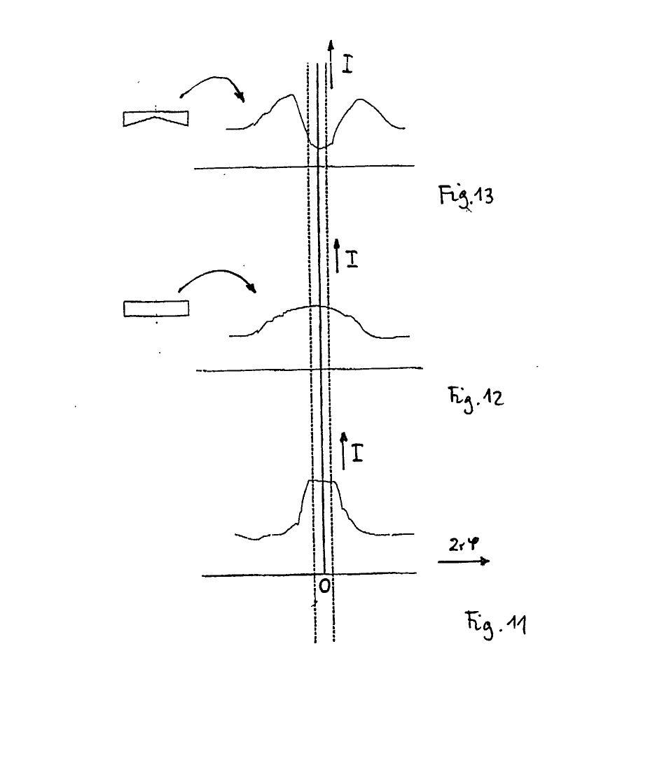

The use of an optical element 11b provided with faces inclined with respect to one another (FIG. 9) even leads, in accordance with FIG. 13, to a power density minimum in the region of the opening 8, and, thus, to particularly low reflector losses.

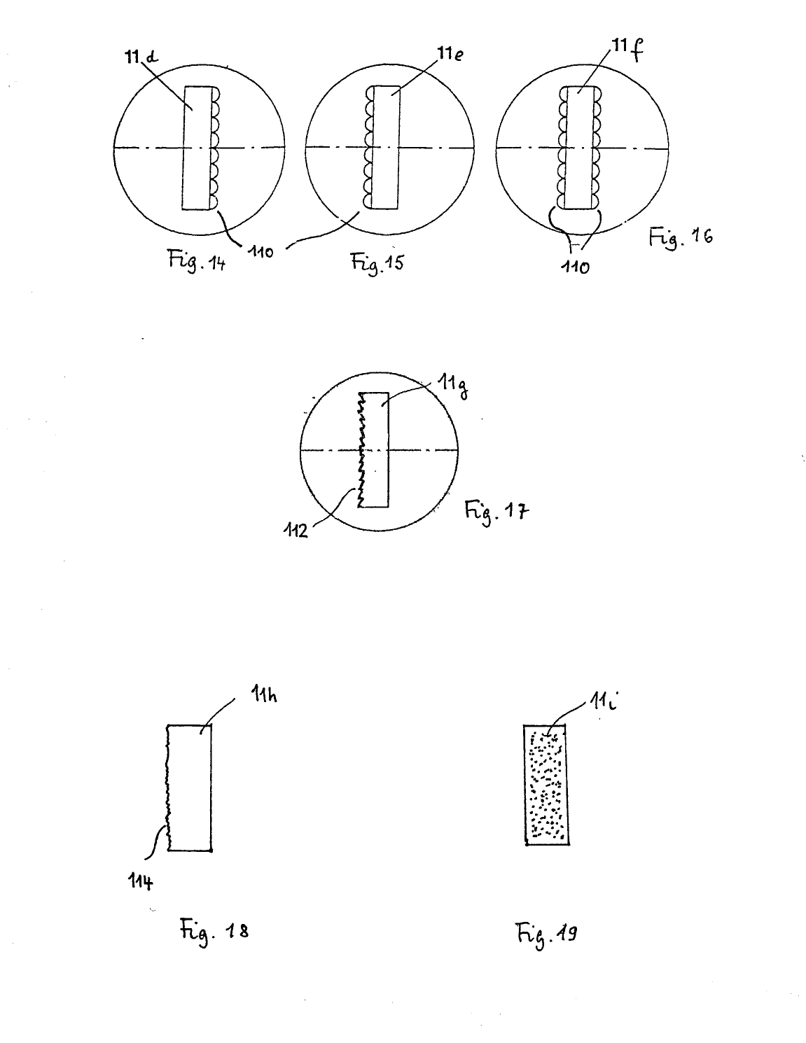

Provided in accordance with FIGS. 14 to 16 are optical elements lid, lie, 11f that are provided respectively with a microlens array 110 at their light exit face or at their light entrance face or both at the light exit face and at the light entrance face. The pumping radiation can be distributed in the volume inside the pumping radiation reflector 7 in a defined fashion due to the surface configuration. The microlens array 110 can, moreover, be fashioned such that a different shaping of the radiation takes place both in the axial direction and in the radial direction.

Instead of an optical element provided with a microlens array, in accordance with FIG. 10 it is also possible to provide an optical element 11g that has an imaging diffractive structure 112 on its light entrance and/or light exit face.

In accordance with FIG. 18, an optical element 11h has, on its light entrance and/or light exit face, a diffusely scattering surface 114 produced, for example, by roughening.

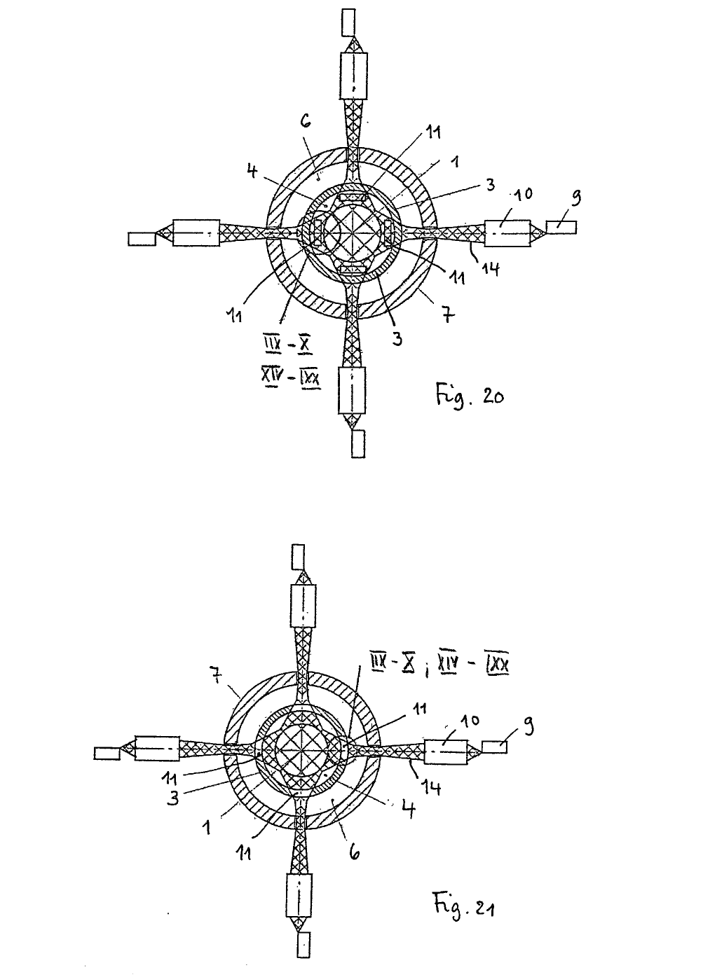

As an alternative thereto, it is also possible in accordance with FIG. 19 to provide an optical element 11i that scatters the pumping radiation in its volume and is formed from a milk glass or opal glass or from a glass ceramic, for example, a pretreated quartz glass.

The direction of propagation of the pumping radiation 14 can be modified specifically with the aid of the optical elements 11a to 11g (beam deflection by refraction and/or diffraction). By contrast, instead of a beam deflection, the optical elements 11h, 11i (FIGS. 18, 19) effect a diffuse scattering of the pumping radiation by influencing the direction of propagation of the pumping light beam such that the power density of the pumping radiation is, on one hand, reduced and, on the other hand, homogenized after passage through the optical element.

In principle, the optical elements lid to 11g (FIGS. 14 to 17) can also influence the pumping optical radiation such that they act like a scattering optical element. The scattering can be achieved, for example, by very short focal lengths of the microlenses or of the diffractive structure.

In a further exemplary embodiment, the optical elements 11 are disposed in accordance with FIG. 20 inside the cooling jacket 3.

FIG. 21 shows a particularly advantageous refinement in which the optical elements 11a to 11i are integrated directly into the cooling jacket 3. Such an embodiment can be implemented easily in terms of production engineering by appropriate shaping of the inner and/or outer surface of the cooling jacket 3, in particular, with the aid of the optical elements 11a, 11b, 11c, 11h.

It is evident that the figures illustrate the configuration according to the invention only schematically. The cross-sectional dimension of the optical element 11, which is configured as a lens-shaped element or as a diffusely scattering element, for example, is a function of the basic dimensioning of the laser configuration. It is to be ensured in this case that when use is made of optical elements with a comparatively high reflection (diffusely scattering elements) only as low as possible a fraction of the surface of the cooling jacket or of an imaginary lateral surface around the laser medium is covered by the optical elements to avoid losses in efficiency (due to reflection between optical elements and reflector). At the same time, the optical element must have sufficient surface area to influence the substantial fraction of the pumping radiation coming directly from the pumping radiation source that would strike the laser medium without reflection at the reflector.

We claim:

1. An optically pumped solid-state laser, comprising:
a pumping radiation reflector having at least one opening for injecting into said pumping radiation reflector pumping radiation to be emitted in a beam path by a pumping radiation source;
a laser medium surrounded by said pumping radiation reflector; and
a beam altering optical system disposed between the pumping radiation source and said laser medium, said beam altering optical system having at least one optical element disposed inside said pumping radiation reflector in the beam path of the pumping radiation source, said optical element varying a power density distribution of at least a portion of the pumping radiation directed immediately onto said laser medium.

2. The optically pumped solid-state laser according to claim 1, wherein said optical element has a diffusely scattering surface.

3. The optically pumped solid-state laser according to claim 2, wherein said optical element has:
a radiation entrance;
a radiation exit face; and
a microlens configuration on at least one of said radiation entrance and said radiation exit face.

4. The optically pumped solid-state laser according to claim 2, wherein said optical element is a diffractive optical system.

5. The optically pumped solid-state laser according to claim 1, wherein said optical element has a volume and scatters the pumping radiation in said volume.

6. The optically pumped solid-state laser according to claim 5, wherein said optical element is of a milk glass.

7. The optically pumped solid-state laser according to claim 5, wherein said optical element is formed from a milk glass.

8. The optically pumped solid-state laser according to claim 1, wherein said optical element effects a change in the power density distribution of the pumping radiation by a beam deflection.

9. The optically pumped solid-state laser according to claim 1, wherein said optical element deflects the beam of the pumping radiation to change the power density distribution of the pumping radiation.

10. The optically pumped solid-state laser according to claim 8, wherein said pumping radiation reflector has a diffusely reflecting surface.

11. The optically pumped solid-state laser according to claim 1, wherein said pumping radiation reflector has a diffusely reflecting surface.

12. The optically pumped solid-state laser according to claim 8, wherein said optical element has:
a radiation entrance;
a radiation exit face; and
a microlens configuration on at least one of said radiation entrance and said radiation exit face.

13. The optically pumped solid-state laser according to claim 8, wherein said optical element is a diffractive optical system.

14. The optically pumped solid-state laser according to claim 13, wherein said optical element is a diffractive optical system.

15. The optically pumped solid-state laser according to claim 1, including a cooling jacket transparent to the pumping radiation, said cooling jacket having a wall and surrounding said laser medium, said optical element being integrated into said wall of said cooling jacket.

16. The optically pumped solid-state laser according to claim 15, wherein:
said cooling jacket has an outer circumference and an inner circumference; and
said optical element is mounted on at least one of said outer circumference and said inner circumference of said cooling jacket.

17. The optically pumped solid-state laser according to claim 15, wherein said optical element is recessed into said cooling jacket.

18. The optically pumped solid-state laser according to claim 15, wherein:
said laser medium has an imaginary lateral surface therearound; and
said optical element only partially covers one of said cooling jacket and said imaginary lateral surface around said laser medium.

19. The optically pumped solid-state laser according to claim 1, wherein:
said laser medium has an imaginary lateral surface therearound;
a cooling jacket transparent to the pumping radiation surrounds said laser medium; and
said optical element only partially covers one of said cooling jacket and said imaginary lateral surface around said laser medium.

20. The optically pumped solid-state laser according to claim 19, wherein:
said cooling jacket has a wall; and
said optical element is integrated into said wall of said cooling jacket.

21. The optically pumped solid-state laser according to claim 1, wherein said optical element has dimensions and positions selected to detect only a fraction of the pumping radiation directed immediately onto said laser medium.

22. The optically pumped solid-state laser according to claim 1, wherein:
said optical element is associated with said at least one opening of said pumping radiation reflector;
said laser medium has axis;
said optical element has a radiation entrance face; and
said radiation entrance face is tilted at an angle other than 90° with respect to a line between the pumping radiation source and said axis of said laser medium causing at least a portion of the pumping radiation reflected at said radiation entrance face to substantially impinge on said pumping radiation reflector next to said at least one opening.

23. The optically pumped solid-state laser according to claim 1, wherein said at least one opening is a plurality of openings circumferentially spaced apart from one another about said pumping radiation reflector for injecting pumping radiation into said pumping radiation reflector.

24. The optically pumped solid-state laser according to claim 23, wherein:
said pumping radiation reflector has a circumference; and
said openings are distributed uniformly around said circumference.

25. The optically pumped solid-state laser according to claim 23, wherein:
said laser medium has a given length; and
said openings are slits having a length approximately equal to said given length.

26. The optically pumped solid-state laser according to claim 1, wherein:
said at least one opening is a plurality of openings for injecting pumping radiation into said pumping radiation reflector;
said laser medium has a given length; and
said openings are slits having a length approximately equal to said given length.

27. The optically pumped solid-state laser according to claim 1, wherein:
said optical element has:
a radiation entrance;
a radiation exit face; and
at least one of said radiation entrance and said radiation exit face has a coating.

28. The optically pumped solid-state laser according to claim 22, wherein:
said optical element has a dielectric reflective coating; and
said pumping radiation reflector substantially shapes the pumping radiation.

29. The optically pumped solid-state laser according to claim 28, wherein said pumping radiation reflector substantially shapes the pumping radiation both in a radial direction and in an axial direction of the beam path.

30. The optically pumped solid-state laser according to claim 1, wherein:
said optical element has a dielectric reflective coating; and
said pumping radiation reflector substantially shapes the pumping radiation.

31. The optically pumped solid-state laser according to claim 30, wherein said pumping radiation reflector substantially shapes the pumping radiation both in a radial direction and in an axial direction of the beam path.

32. The optically pumped solid-state laser according to claim 1, wherein said pumping radiation reflector substantially shapes the pumping radiation both in a radial direction and in an axial direction of the beam path.

33. The optically pumped solid-state laser according to claim 1, wherein said laser medium is a solid body doped with an optically active ion from elements selected from the group consisting of transition metals and rare earths and has a doping less than 1 atomic percent.

34. The optically pumped solid-state laser according to claim 1, wherein said laser medium has a doping less than 0.5 atomic percent.

35. The optically pumped solid-state laser according to claim 1, wherein said laser medium has a doping less than 0.3 atomic percent.

36. The optically pumped solid-state laser according to claim 1, wherein said laser medium has a doping between 0.05 and 0.3 atomic percent.

37. The optically pumped solid-state laser according to claim 33, wherein said laser medium:
is YAG doped with neodymium Nd; and
has a doping less than 0.3 atomic percent.

38. The optically pumped solid-state laser according to claim 33, wherein said laser medium:
is YAG doped with neodymium Nd; and
has a doping between 0.05 and 0.3 atomic percent.

39. The optically pumped solid-state laser according to claim 33, wherein the pumping radiation source is one of a diode laser and a diode laser configuration.

40. The optically pumped solid-state laser according to claim 1, wherein the pumping radiation source is one of a diode laser and a diode laser configuration.

41. The optically pumped solid-state laser according to claim 1, wherein said beam altering optical system is a system selected from the group consisting of a beam guiding optical system, a beam shaping optical system, and a beam guiding and shaping optical system.

42. An optically pumped solid-state laser system, comprising:
a pumping radiation source emitting pumping radiation in a beam path, the pumping radiation having a power density distribution;
a pumping radiation reflector having at least one opening optically connected to said pumping radiation source for injecting into said pumping radiation reflector the pumping radiation;
a laser medium surrounded by said pumping radiation reflector; and
a beam altering optical system optically disposed between said pumping radiation source and said laser medium, said beam altering optical system having at least one optical element disposed inside said pumping radiation reflector in said beam path of said pumping radiation source, said optical element varying the power density distribution of at least a portion of the pumping radiation directed immediately onto said laser medium.

43. The optically pumped solid-state laser according to claim 42, wherein said pumping radiation source is one of a diode laser and a diode laser configuration.
